(19) United States
(12) Patent Application Publication
(10) Pub. No.: US 2025/0226611 A1
(43) Pub. Date: Jul. 10, 2025

(54) TENON-AND-MORTISE CONNECTOR

(71) Applicant: JIANGMEN KREALUX ELECTRICAL APPLIANCES CO., LTD., Guangdong (CN)

(72) Inventor: Xiaopo RAO, Guangdong (CN)

(73) Assignee: JIANGMEN KREALUX ELECTRICAL APPLIANCES CO., LTD., Guangdong (CN)

(21) Appl. No.: 19/091,782

(22) Filed: Mar. 26, 2025

Related U.S. Application Data
(63) Continuation-in-part of application No. PCT/CN2024/104772, filed on Jul. 10, 2024.

(30) Foreign Application Priority Data
Jul. 11, 2023 (CN) 202310846939.9

(51) Int. Cl. H01R 13/52; H01R 4/48

(52) U.S. Cl. CPC H01R 13/5205; H01R 4/48

(57) ABSTRACT

The disclosure relates to a tenon-and-mortise connector, which comprises a first connecting terminal and a second connecting terminal, wherein: the first connecting terminal comprises a first connecting terminal shell and a tenon gland, one end of the first connecting terminal shell is provided with a first wire inlet hole, the tenon gland is provided with a tenon connecting part extending along a first wire inlet direction, and a tenon clamping device is arranged in the first connecting terminal; the second connecting terminal comprises a second connecting terminal shell and a mortise gland, one end of the second connecting terminal shell is provided with a second wire inlet hole, the mortise gland is provided with a mortise connecting part capable of being plugged with the tenon connecting part, and a mortise clamping device is arranged in the second connecting terminal.

### CROSS REFERENCE TO RELATED APPLICATIONS

The present application is a continuation-in-part application of international PCT application serial no. PCT/CN2024/104772, filed on Jul. 10, 2024, which claims the priority of the Chinese patent with the application Ser. No. 202310846939.9, filed with China National Intellectual Property Administration on Jul. 11, 2023, which is incorporated in its entirety herein by reference.

### TECHNICAL FIELD

The present disclosure relates to the technical field of connectors, and more particularly, to a tenon-and-mortise connector.

### BACKGROUND

With the development of science and technology, a connecting terminal has the effects of wiring and electrifying, realizes a good connection function of wiring and electrifying, and is an important wiring component for connecting electrical appliances and connecting a wiring terminal and a wiring terminal. Generally, the connecting terminal can only be used in conjunction with a single connecting terminal, installation of wires can only be completed by using an auxiliary tool between a plurality of connecting terminals, and the assembly is inconvenient. Therefore, a structure of the existing connecting terminal needs to be improved.

### SUMMARY

Based on this, in order to overcome at least one defect of the prior art, the present disclosure provides a tenon-and-mortise connector which has simple structure, can be plugged for use and is convenient to assemble.

A tenon-and-mortise connector, comprises a first connecting terminal and a second connecting terminal, wherein:
the first connecting terminal comprises a first connecting terminal shell and a tenon gland, one end of the first connecting terminal shell is provided with a first wire inlet hole, the tenon gland is provided with a tenon connecting part extending along a first wire inlet direction, a tenon clamping device is arranged in the first connecting terminal, and the tenon clamping device comprises a tenon clamping spring and a first contact connected with the tenon clamping spring;
the second connecting terminal comprises a second connecting terminal shell and a mortise gland, one end of the second connecting terminal shell is provided with a second wire inlet hole, the mortise gland is provided with a mortise connecting part capable of being plugged with the tenon connecting part, a mortise clamping device is arranged in the second connecting terminal, and the mortise clamping device comprises a mortise clamping spring and a second contact connected with the mortise clamping spring;
the first connecting terminal and/or the second connecting terminal is provided with a disconnecting device, and the disconnecting device is used for opening or closing the tenon clamping device and/or the mortise clamping device; and
the tenon connecting part and the mortise connecting part are capable of being plugged, and after the tenon connecting part and the mortise connecting part are plugged, the first contact and the second contact are electrically connected.

In one embodiment, the tenon gland comprises a tenon socket and the tenon connecting part, the tenon socket comprises a top surface and a first connecting surface connected with a front end of the top surface, and the tenon connecting part is formed on the first connecting surface; and
the mortise gland comprises a mortise socket and the mortise connecting part, the mortise socket comprises a top surface and a second connecting surface connected with a front end of the top surface, and the mortise connecting part is formed on the second connecting surface.

In one embodiment,
the tenon connecting part and the tenon socket form a convex shape, and/or,
the mortise connecting part and the mortise socket form a convex shape.

In one embodiment,
the tenon gland and/or the mortise gland are provided with locking mechanisms to fix connection states of the tenon connecting part and the mortise connecting part.

In one embodiment, the locking mechanism comprises one or more convex ribs arranged on an outer wall of the mortise connecting part in a length direction of the mortise connecting part, and grooves arranged on the tenon connecting part and matched with the convex ribs.

In one embodiment, the tenon connecting part and the mortise connecting part are further installed and fixed by fastening and fixing of a clamping assembly.

In one embodiment, the clamping assembly comprises a cantilever-like fastener arranged on the second connecting surface and extending along the second wire inlet direction, and a clamping slot for fastening arranged on the tenon connecting part, and when the first connecting terminal and the second connecting terminal are plugged and paired, the cantilever-like fastener is fastened and fixed on the clamping slot for fastening.

In one embodiment, an extension end of the cantilever-like fastener is provided with a hook protruding upwards, and the hook is clamped in the clamping slot for fastening.

In one embodiment, the hook is provided with an anti-slip strip.

In one embodiment,
the first connecting terminal further comprises a first connecting terminal shell, the first connecting terminal shell and the tenon gland form a first housing at the first opening in a left-right split mode, and at least one accommodating channel penetrating through the first housing is formed in the first housing; and the second connecting terminal further comprises a second connecting terminal shell, the second connecting terminal shell and the mortise gland form a second housing at the second opening in a left-right split manner, and at least one accommodating channel penetrating through the second housing is formed in the second housing.

In one embodiment,
one end of the first connecting terminal shell is a first wire inlet hole, and the other end of the first connecting terminal shell is fixedly connected with the tenon socket through the first opening; and one end of the second connecting terminal shell is a second wire inlet hole, and the other end of the second connecting terminal shell is fixedly connected with the mortise socket through the second opening.

In one embodiment,
a top of the first connecting terminal shell is a first plugboard assembly extending from a top of the first wire inlet hole to a rear end of the first connecting terminal shell, the first plugboard assembly comprises at least one first plugboard, one end of the first plugboard is fixedly integrated with the top of the first wire inlet hole, and the other end of the first plugboard is inserted into the tenon gland to form installation and fixation; and
a top of the second connecting terminal shell is a second plugboard assembly extending from a top of the second wire inlet hole to a rear end of the second connecting terminal shell, the second plugboard assembly comprises at least one second plugboard, one end of the second plugboard is fixedly integrated with the top of the second wire inlet hole, and the other end of the second plugboard is inserted into the mortise gland to form installation and fixation.

In one embodiment, the first connecting terminal shell is fixedly connected with the tenon socket through a first clamping assembly; and/or, the second connecting terminal shell is fixedly connected with the mortise socket through a second clamping assembly.

In one embodiment,
the first clamping assembly comprises a first bottom-surface clamping convex head which is arranged on a bottom surface of the first connecting terminal shell and protrudes out, and a tenon bottom clamping slot which is arranged on a bottom of the tenon socket and matched and fastened with the first bottom-surface clamping convex head; and/or, a first top-surface clamping convex head which is arranged on a top surface of a first plugboard and protrudes out, and a tenon top clamping slot which is arranged on a top of the tenon socket and matched and fastened with the first top-surface clamping convex head; and
the second clamping assembly comprises a second bottom-surface clamping convex head which is arranged on a bottom surface of the second connecting terminal shell and protrudes out, and a mortise bottom clamping slot which is arranged on a bottom of the mortise socket and matched and fastened with the second bottom-surface clamping convex head; and/or, a second top-surface clamping convex head which is arranged on the a surface of a second plugboard and protrudes out, and a mortise top clamping slot which is arranged on a top of the mortise socket and matched and fastened with the second top-surface clamping convex head.

According to the tenon-and-mortise connector above, a first side wall of the first connecting terminal shell is provided with a first coupling part, a second side wall of the first connecting terminal shell opposite to the first side wall is provided with a second coupling part matched with the first coupling part, and a first coupling part or a second coupling part of the second connecting terminal shell is configured to be detachably coupled with a second coupling part or a first coupling part of another connecting terminal shell to connect the connecting terminal shell and another connecting terminal shell in parallel.

According to the tenon-and-mortise connector above, the first coupling part comprises a first protruding part which protrudes out of the first side wall parallel to an insertion direction, and the first protruding part is U-shaped; and the second coupling part comprises a second groove concave out of the second side wall parallel to the insertion direction, and the first protruding part is inserted in a second groove of another connecting terminal shell.

In one embodiment, the second contact is a pin sleeve with a sleeve-like structure, the first contact is a pin head extending into the pin sleeve to realize electrical connection with the pin sleeve, the tenon clamping device further comprises a tenon connecting piece, and the tenon clamping spring, the tenon connecting piece and the pin head are sequentially connected, and/or the mortise clamping device further comprises a mortise connector, and the mortise clamping spring, the mortise connector and the pin sleeve are sequentially connected

The tenon clamping spring comprises a front tenon metal sheet and a tenon bus bar, and the tenon connecting piece connects the bus bar with the pin head.

In one embodiment, the tenon clamping device is integrally formed, and/or, the mortise clamping device is integrally formed.

In one embodiment, a side wall of the pin sleeve is provided with a limiting lug.

In one embodiment, the pin sleeve is provided with one expansion joint penetrating through a tube wall.

In one embodiment, the pin sleeve is further provided with one expansion joint.

In one embodiment, the expansion joint is one joint not penetrating the tube wall.

In one embodiment, the pin head is a cylindrical pin.

In one embodiment, an upper part of the pin head is provided with at least one expansion joint, and a width of the expansion joint gradually narrows towards a pin opening direction.

In one embodiment, the disconnecting device comprises a first disconnecting device and a second disconnecting device, one end of the first disconnecting device extends into the first housing for squeezing the tenon clamping spring to open or close the tenon clamping device, and the other end of the first disconnecting device protrudes out of the first housing; and one end of the second disconnecting device extends into the second housing for squeezing the mortise clamping spring to open or close the mortise clamping device, the disconnecting device comprises a connecting arm, two side-by-side supporting arms connected with the connecting arm and a coupling arm located in the middle of the supporting arms, and the other end of the second disconnecting device protrudes out of the second housing.

In one embodiment, the tenon gland is provided with at least one tenon test port, and/or the mortise gland is provided with at least one mortise test port.

In one embodiment, the tenon-and-mortise connector further comprises an upper cover and a lower seat, and the upper cover and the lower seat form a wire protection box by up-down splicing; and the first connecting terminal and/or the second connecting terminal is installed in a space formed between the upper cover and the lower seat.

In one embodiment, the upper cover and the lower seat are connected by a screw and/or a buckle.

In one embodiment, the lower seat comprises a lower seat body, the lower seat body is provided with a clamping piece, one end of the clamping piece is fixed on a side wall of the lower seat body, and the other end of the clamping piece is clamped with an upper cover body.

In one embodiment, the upper cover comprises an upper cover body, and a front part of the upper cover body is provided with a wire clip with plastic elasticity.

In one embodiment, the tenon-and-mortise connector further comprises a wire protection box, the wire protection box comprises an upper cover and a lower seat, and the upper cover is hinged on the lower seat.

In one embodiment, a positioning space for positioning the first connecting terminal or the second connecting terminal is formed between the lower seat and the upper cover, a fitting groove for exposing the tenon connecting part or the mortise connecting part of the first connecting terminal or the second connecting terminal is arranged at the front of the positioning space, and a through hole for leading a wire to penetrate and extend to an outside is arranged at the rear of the positioning space.

In one embodiment, the tenon gland is provided with at least one tenon upper cover clamping slot, and/or the mortise gland is provided with at least one mortise upper cover clamping slot. The upper cover comprises an upper cover wall and two upper cover side walls connected with the upper cover wall, and a front end of the upper cover side wall is provided with an upper cover clamping port matched with the tenon upper cover clamping slot or the mortise upper cover clamping slot.

In one embodiment, a rear side of the upper cover wall is provided with a jack, a rear part of the jack is fixedly connected with a wire clip, the wire clip comprises a connecting section and a cantilever section, the connecting section is fixed on the rear part of the jack of the upper cover wall, and the cantilever section extends into an upper cover groove, is deformable and is used for elastically abutting against a wire inserted into the through hole.

In one embodiment, the upper cover and the lower seat are connected by a screw and/or buckled by a clamping assembly, the clamping assembly comprises a clamping piece arranged at a rear end of the lower seat, and a position at a rear end of the upper cover side wall corresponding to the clamping piece is provided with a clamping groove which realizes clamping with the clamping piece.

In one embodiment, the lower seat comprises a lower seat base and two lower seat side walls connected with the lower seat base, the clamping piece is a strip-shaped plate structure arranged longitudinally and extending upwards from the lower seat base along the lower seat side walls, and a tail end of the clamping piece is provided with a clamping buckle.

The lower seat comprises a lower seat base and two lower seat side walls connected with the lower seat base, a front end of the lower seat side wall is provided with a lower seat groove for placing the first connecting terminal or the second connecting terminal, the lower seat base is further provided with a lower seat jack, and the lower seat jack is provided with an elastically deformable fastener.

In one embodiment, two sides of a front end of the upper cover are provided with rotating shafts, and two sides of a front end of the lower seat are provided with fixing arms matched with the rotating shafts, and the upper cover is hinged on the fixing arms of the lower seat through the rotating shafts.

In one embodiment, an I-shaped locking pin is arranged at a tail end of the rotating shaft.

In one embodiment, a side wall of the upper cover body is provided with at least one reinforcing rib, and/or a side wall of the lower seat body is provided with at least one reinforcing rib.

In one embodiment, an outer side of the side wall of the lower seat body is provided with an anti-skid stripe.

In one embodiment, a joint of the clamping piece and the lower seat base is provided with at least one rack transversely penetrating the lower seat base to fix a wire.

The gland structure of the tenon-and-mortise connector according to the present disclosure at least has the following beneficial effects that: the present disclosure can connect two at least connecting terminals simultaneously through configuring the tenon gland and the mortise gland that can be matched for use, so that the structure is simple and the assembly is convenient.

### BRIEF DESCRIPTION OF THE DRAWINGS

FIG. 1 is a front view of a tenon-and-mortise connector according to a first embodiment of the present disclosure;

FIG. 2 is a perspective view of the tenon-and-mortise connector according to the first embodiment of the present disclosure;

FIG. 3 is a perspective view of the tenon-and-mortise connector according to the first embodiment of the present disclosure;

FIG. 4 is a C-C sectional view of a tenon of the tenon-and-mortise connector in FIG. 1;

FIG. 5 is an A-A sectional view of a mortise of the tenon-and-mortise connector in FIG. 1;

FIG. 6 is a perspective view of a tenon gland of the tenon-and-mortise connector in FIG. 1;

FIG. 7 is a perspective view of the tenon gland of the tenon-and-mortise connector in FIG. 1;

FIG. 8 is a perspective view of a mortise gland of the tenon-and-mortise connector in FIG. 1;

FIG. 9 is a perspective view of the mortise gland of the tenon-and-mortise connector in FIG. 1; FIG. 10 is a perspective view of a first connecting terminal shell of the tenon-and-mortise connector in FIG. 1;

FIG. 11 is a perspective view of the first connecting terminal shell of the tenon-and-mortise connector in FIG. 1;

FIG. 12 is a perspective view of a second connecting terminal shell of the tenon-and-mortise connector in FIG. 1;

FIG. 13 is a perspective view of the second connecting terminal shell of the tenon-and-mortise connector in FIG. 1;

FIG. 14 is a perspective view of a tenon clamping device of the tenon-and-mortise connector in FIG. 1;

FIG. 15 is a perspective view of the tenon clamping device of the tenon-and-mortise connector in FIG. 1;

FIG. 16 is a perspective view of a mortise clamping device of the tenon-and-mortise connector in FIG. 1;

FIG. 17 is a perspective view of the mortise clamping device of the tenon-and-mortise connector in FIG. 1;

FIG. 18 is a perspective view of a first disconnecting device of the tenon-and-mortise connector in FIG. 1;

FIG. 19 is a perspective view of the first disconnecting device of the tenon-and-mortise connector in FIG. 1;

FIG. 20 is a perspective view of a second disconnecting device of the tenon-and-mortise connector in FIG. 1;

FIG. 21 is a perspective view of the second disconnecting device of the tenon-and-mortise connector in FIG. 1;

FIG. 22 is a perspective view of an upper cover of the tenon-and-mortise connector in FIG. 1;

FIG. 23 is a perspective view of the upper cover of the tenon-and-mortise connector in FIG. 1;

FIG. 24 is a perspective view of a lower seat of the tenon-and-mortise connector in FIG. 1;

FIG. 25 is a perspective view of the lower seat of the tenon-and-mortise connector in FIG. 1;

FIG. 26 is a perspective view of an open or closed state of the tenon-and-mortise connector according to the first embodiment of the present disclosure;

FIG. 27 is a use state diagram of the tenon-and-mortise connector according to the first embodiment of the present disclosure;

FIG. 28 is a perspective view of an open state of the first connecting terminal shell and a wire protection box of the tenon-and-mortise connector in FIG. 1;

FIG. 29 is a perspective view of a disconnecting device of a tenon-and-mortise connector according to a second embodiment of the present disclosure;

FIG. 30 is a perspective view of the disconnecting device of the tenon-and-mortise connector according to the second embodiment of the present disclosure;

FIG. 31 is a perspective view of an upper cover of a tenon-and-mortise connector according to a third embodiment of the present disclosure;

FIG. 32 is a perspective view of the upper cover of the tenon-and-mortise connector according to the third embodiment of the present disclosure;

FIG. 33 is a perspective view of a lower seat of the tenon-and-mortise connector according to the third embodiment of the present disclosure;

FIG. 34 is a perspective view of the lower seat of the tenon-and-mortise connector according to the third embodiment of the present disclosure;

FIG. 35 is a perspective view of the tenon-and-mortise connector according to the third embodiment of the present disclosure;

FIG. 36 is a perspective view of the tenon-and-mortise connector according to the third embodiment of the present disclosure;

FIG. 37 is a perspective view showing matching and installing of the tenon-and-mortise connector according to the first embodiment and the tenon-and-mortise connector according to the third embodiment of the present disclosure;

FIG. 38 is a perspective view showing matching and installing of the tenon-and-mortise connector according to the first embodiment and the tenon-and-mortise connector according to the third embodiment of the present disclosure;

FIG. 39 is a perspective view showing matching and installing of the tenon-and-mortise connector according to the first embodiment and the tenon-and-mortise connector according to the first embodiment of the present disclosure; and

FIG. 40 is a perspective view showing matching and installing of the tenon-and-mortise connector according to the first embodiment and the tenon-and-mortise connector according to the third embodiment of the present disclosure.

### REFERENCE NUMERALS

tenon-and-mortise connector—100; first connecting terminal—200; second connecting terminal—300; and wire protection box 400;
tenon gland—1; tenon connecting part—11; groove—112; circular groove—114; tenon socket—12; tenon top clamping slot—121; tenon bottom clamping slot—122; first connecting surface—13; clamping slot for fastening—116; tenon test port—14; tenon positioning plate—124; lower seat tenon clamping slot—15; tenon socket groove—16; tenon bottom insertion groove—161; tenon side insertion groove—162; and tenon insertion groove—163;
first connecting terminal shell—2; first wire inlet hole—210; first opening—220; plugboard assembly—22; plugboard 221; gap—222; first top-surface clamping convex head—23; second tenon bottom-surface clamping convex head—24; first coupling part—251; and second coupling part—252;
second connecting terminal shell—2′; first wire inlet hole—21′; first opening—220′; plugboard assembly—22′; plugboard—221′; gap—222′; second top-surface clamping convex head—23; second tenon bottom-surface clamping convex head—24′; third coupling part—251′; and fourth coupling part—252′;
first disconnecting device—3; connecting arm—31; supporting arm—32; accommodating area—33; first supporting part—34; second supporting part—35; and bottom of first supporting part—36;
second disconnecting device—3′; connecting arm—31′; supporting arm—32′; accommodating area—33′; first supporting part—34′; second supporting part—35′; and bottom of first supporting part—36′;
tenon clamping device—4; tenon clamping spring—41; tenon spring—411; tenon convex sheet—412; tenon elastic sheet—413; tenon fixing sheet—414; bus bar—415; tenon clamping clip—417; tenon groove—418; pin head—43; tenon connecting piece—42; and expansion joint—431;
upper cover—5; rotating shaft—51; upper cover wall—52; jack—521; upper cover side wall—53; upper cover groove—531; reinforcing rib—532; wire clip—54; connecting section—541; cantilever section—542; upper cover clamping port 55; and convex strip—56;
lower seat—6; fixing arm—61; lower seat base 62; lower seat jack—621; two lower seat side walls—63; anti-skid stripe—65; fastener—66; clamping piece 67; and screw mating hole—68;
mortise gland—7; mortise connecting part—71; convex ring—712; convex rib—714; hook—717; anti-slip strip—718; mortise socket—72; second connecting surface—73; mortise top clamping slot—721; mortise positioning plate—724; second connecting surface—73; mortise bottom clamping slot—722; cantilever-like fastener—716; mortise test port—74; lower seat mortise clamping slot—75; mortise socket groove—76; mortise side insertion groove—761; mortise bottom insertion groove—762; and mortise insertion groove—763; and
mortise clamping device—8; pin sleeve—83; mortise clamping spring—81; mortise spring—811; mortise convex sheet—812; mortise elastic sheet—813; mortise fixing sheet—814; rear mortise metal sheet—815; mortise groove—818; mortise connecting piece—82; limiting lug—831; and non-penetrated expansion joint—833.

### DETAILED DESCRIPTION

In order to make the above objects, features and advantages of the present disclosure be more clearly understood, the specific embodiments of the present disclosure will be described in further detail below with reference to the drawings. Numerous specific details are set forth in the following description to facilitate a thorough understanding of the present disclosure. However, the present disclosure can be implemented in many other ways different from those described herein, and those skilled in the art can make similar improvements without violating the connotation of the present disclosure, so the present disclosure is not limited by the specific embodiments disclosed below.

In the description of the present disclosure, it should be understood that the orientation or positional relationships indicated by the terms “center”, “longitudinal”, “transversal”, “length”, “width”, “thickness”, “up”, “down”, “front”, “back”, “left”, “right”, “vertical”, “horizontal”, “top”, “bottom”, “inside”, “outside”, “clockwise”, “anticlockwise”, “axial”, “radical”, “circumferential” and the like are orientation or positional relationships based on the drawings, which are only for convenience and simplification of the description of the present disclosure, but are not intended to indicate or imply that the indicated device or element must have a specific orientation, be constructed and operated in a specific orientation, and thus, cannot be understood as a limitation to the present disclosure.

Moreover, the terms “first” and “second” are only used for descriptive purposes, but cannot be understood as indicating or implying relative importance, or implicitly indicating the number of indicated technical features. Therefore, the features defined with “first” and “second” can explicitly or implicitly comprise at least one of the features. In the description of the present disclosure, the meaning of “multiple” is two or more than two, such as two, three, and the like, unless otherwise specifically defined.

In the description of the present disclosure, unless expressly stipulated and defined otherwise, terms such as “installation”, “connected”, “connection”, “fixing”, and the like, should be understood broadly, for example, the connection may be fixed connection, or detachable connection or integral connection; may be mechanical connection, and may also be electrical connection; and may be direct connection, may also be indirect connection through an intermediate medium, and may also be internal communication of two elements or interaction relationship of two elements, unless otherwise explicitly defined. The specific meaning of the above terms the present disclosure, can be understood in a specific case by those of ordinary skills in the art.

In the present disclosure, unless expressly stipulated and defined otherwise, the first feature “on” or “under” the second feature may be that the first and second features are in direct contact, or the first and second features may be indirectly through an intermediate medium. Moreover, the first feature “above”, “over” and “upper” the second feature may be that the first feature is directly above or diagonally above the second feature, or it simply means that a height of the first feature is higher than the second feature. The first feature “below”, “under” and “lower” the second feature may be that the first feature is directly below or diagonally below the second feature, or it simply means that the height of the first feature is less than that of the second feature. It should be noted that when an element is called to be “fixed” to another element, it may be directly arranged on another element or there may be an intermediate element. When an element is considered to be “connected” to another element, it may be directly connected to another element or there may be an intermediate element at the same time. Terms such as “vertical”, “horizontal”, “left”, “right”, and similar expressions used herein are only for the purpose of illustration and do not mean that they are the only implementation ways.

### First Embodiment

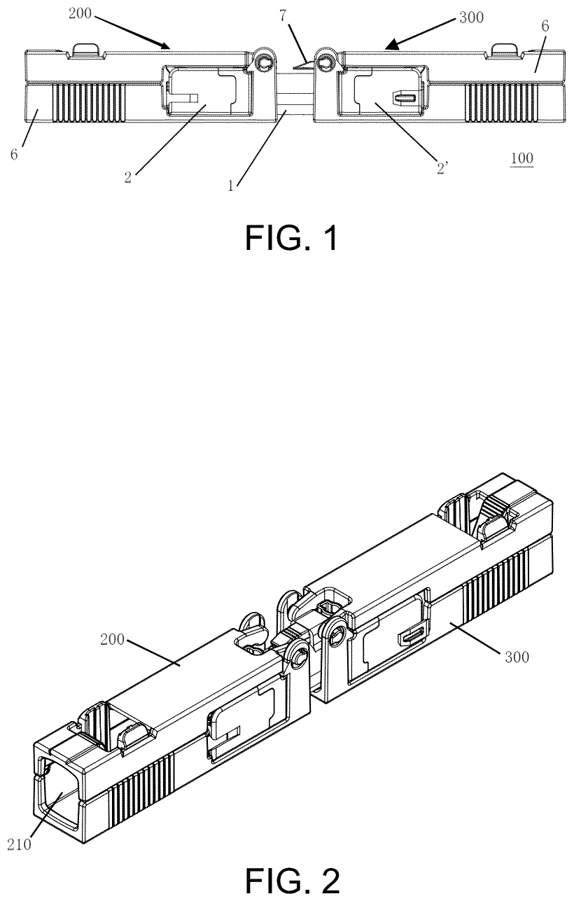

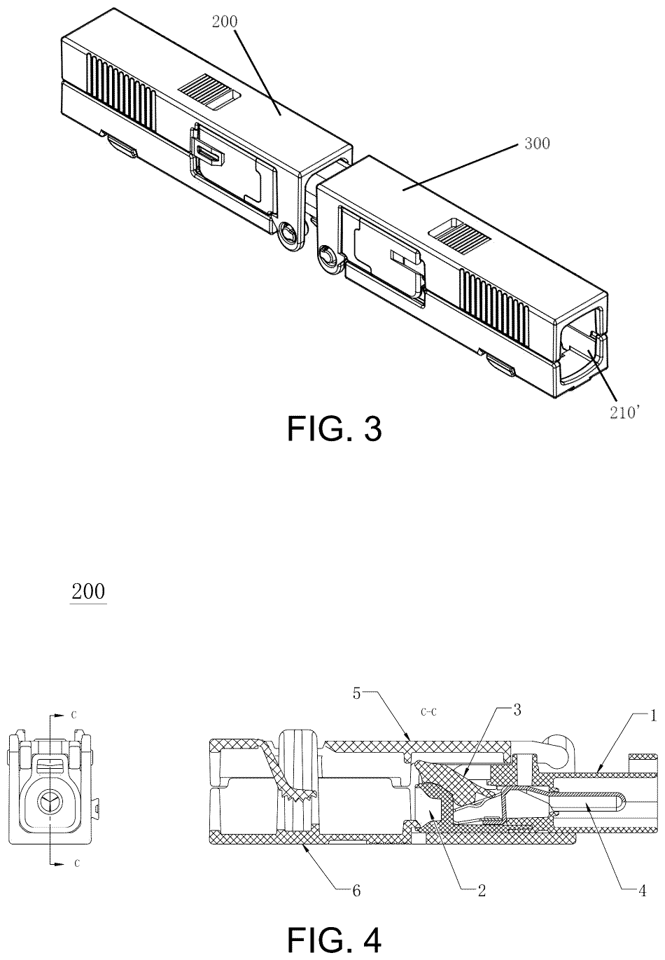

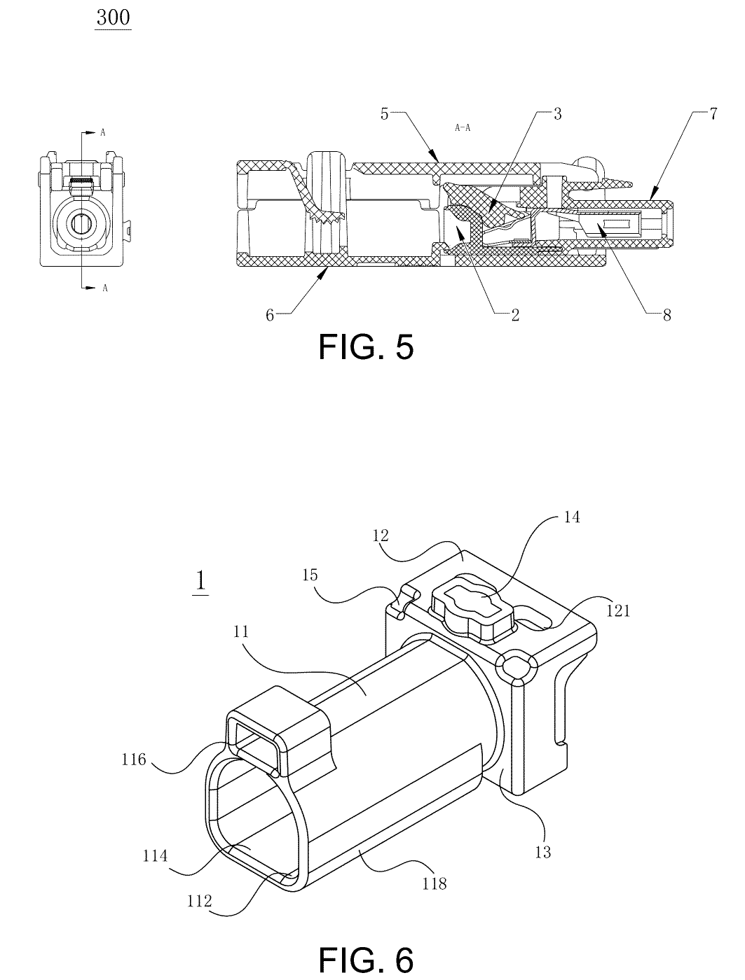

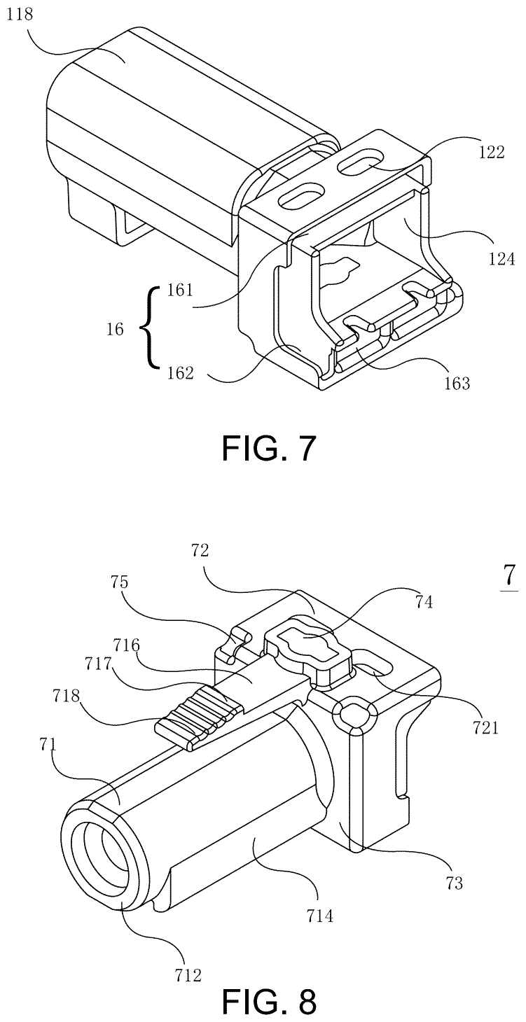

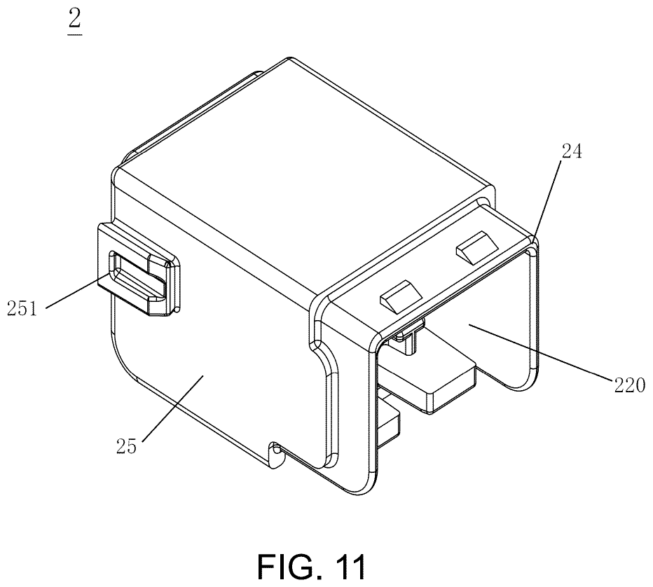

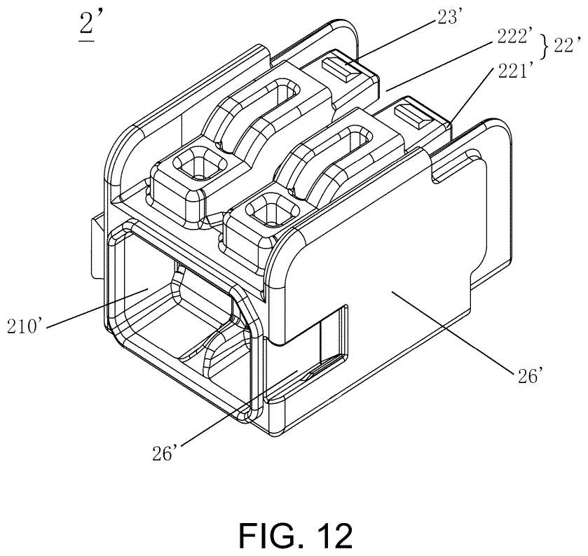

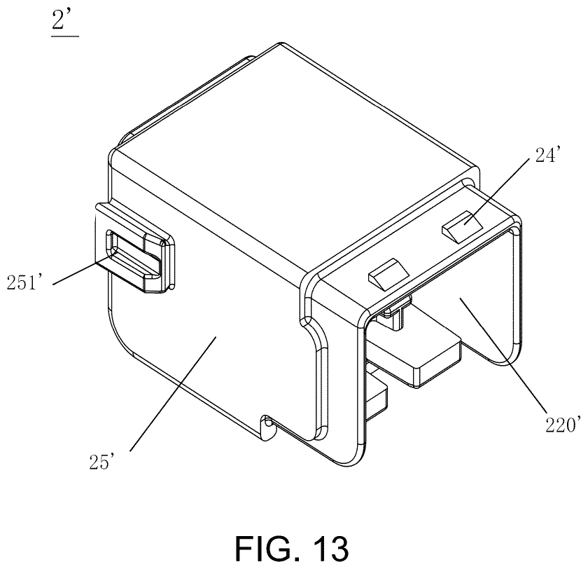

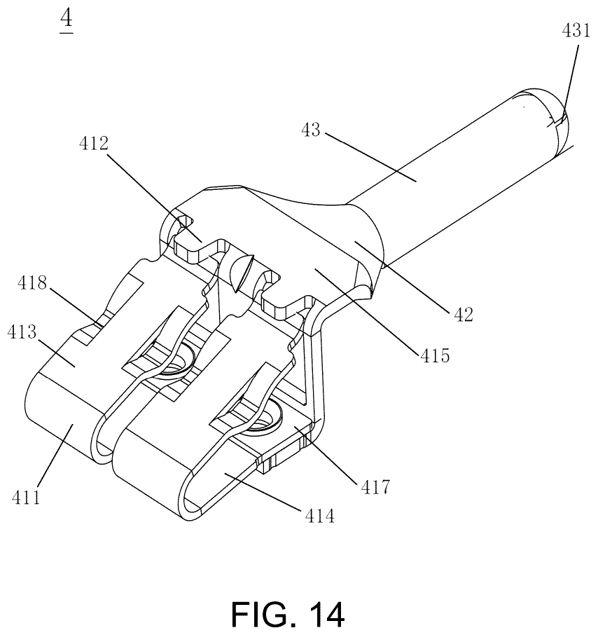

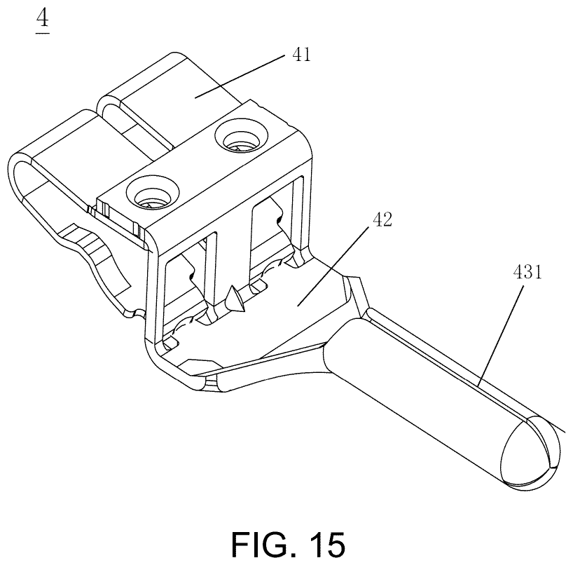

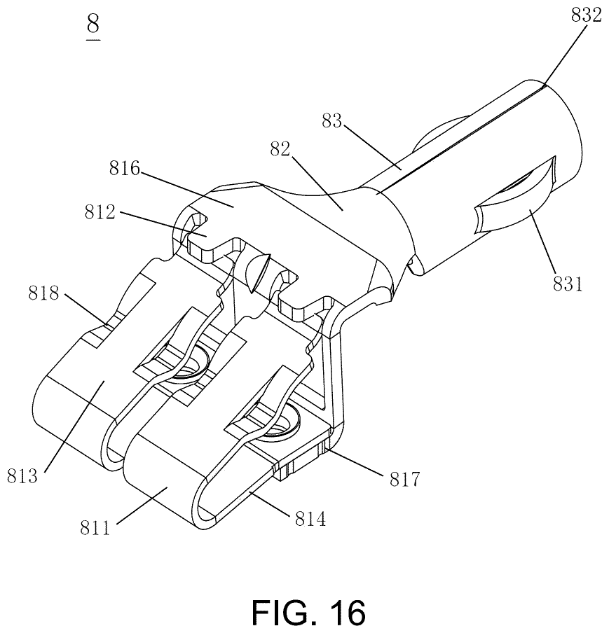

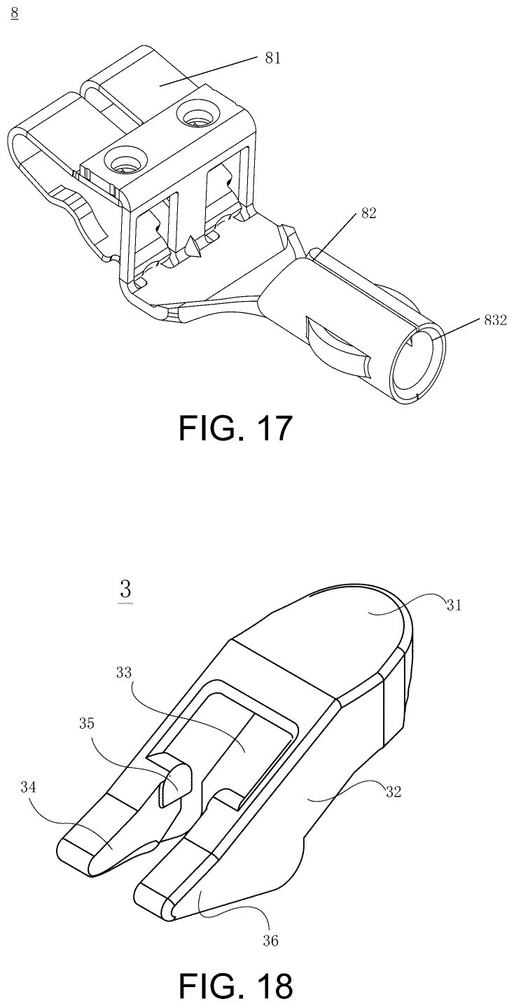

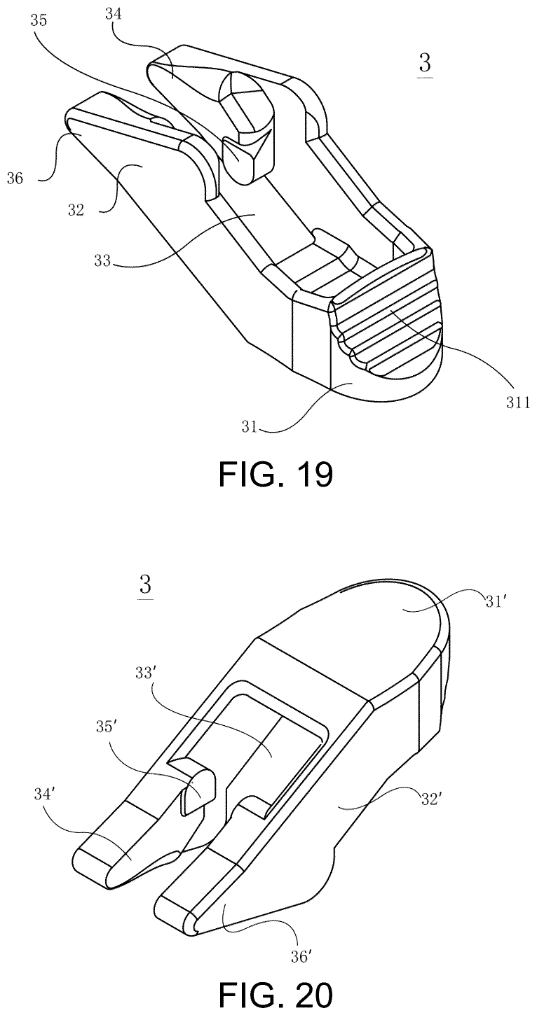

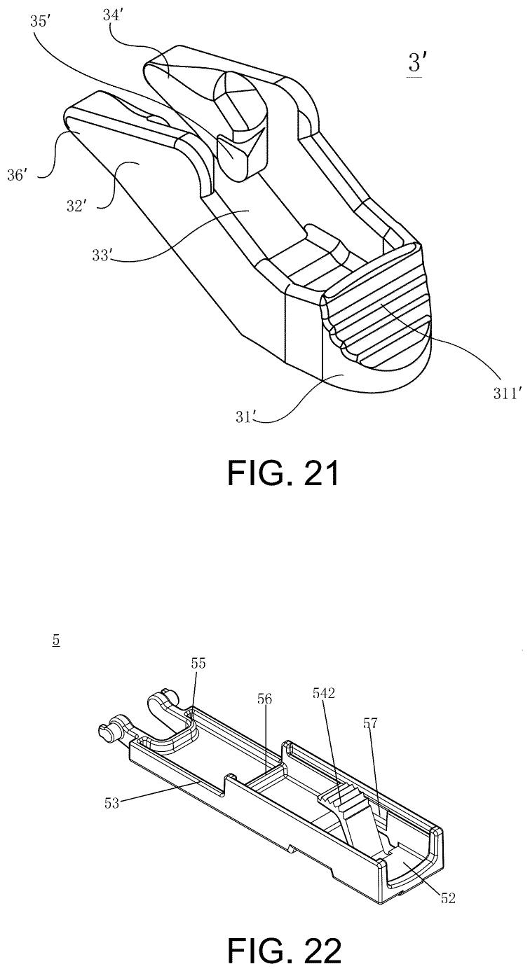

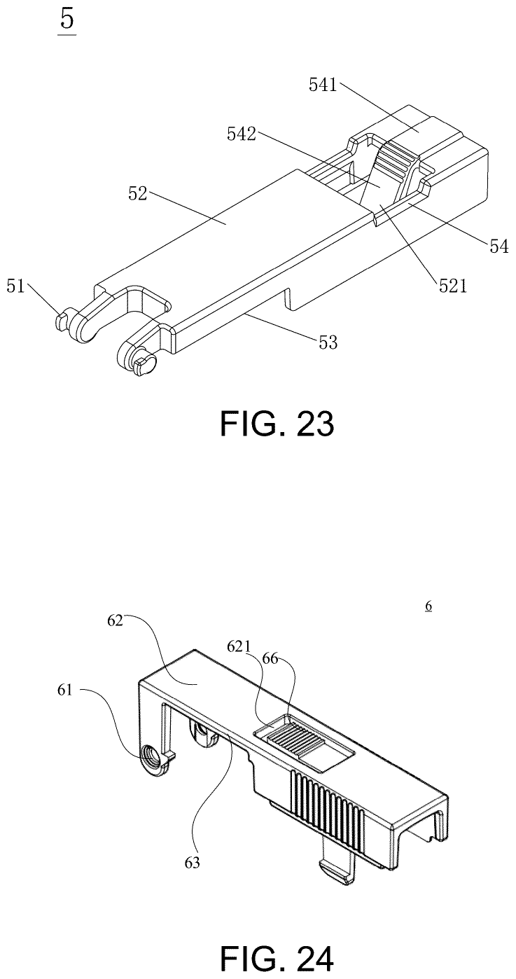

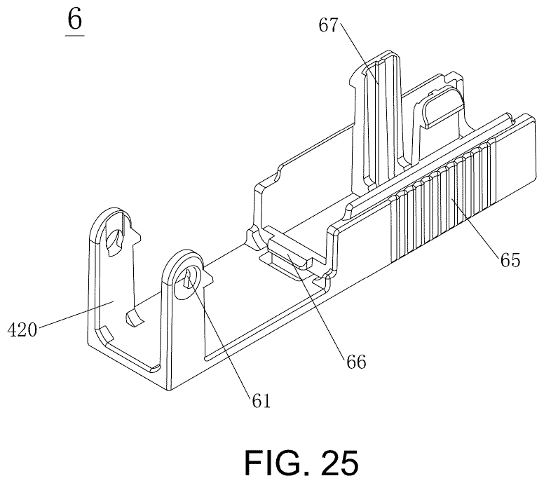

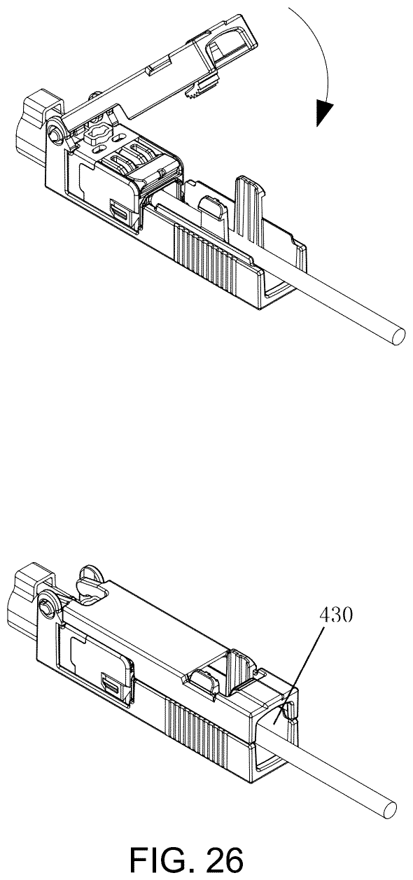

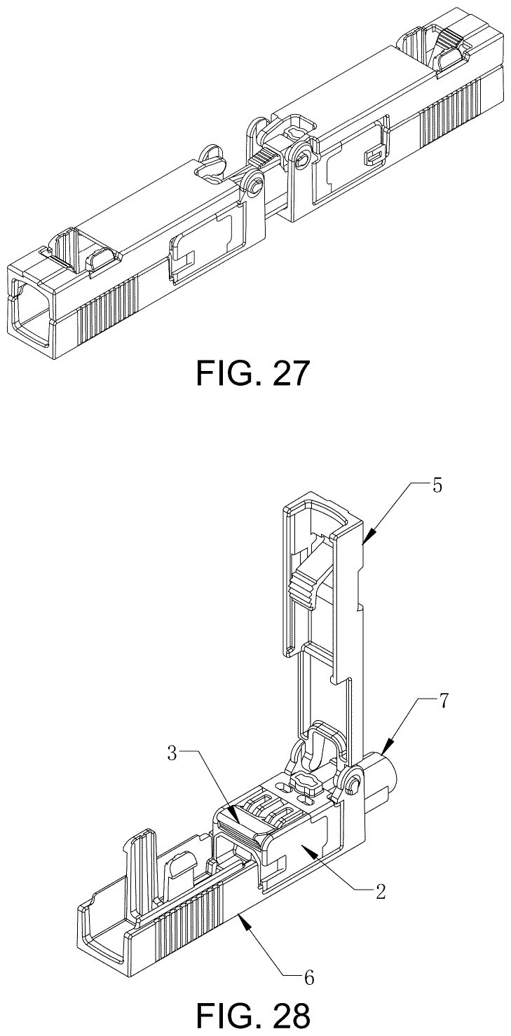

As shown in FIG. 1 to FIG. 28, the present disclosure provides a tenon-and-mortise connector 100, which comprises a first connecting terminal 200 and a second connecting terminal 300. The first connecting terminal 200 is provided with a first wire inlet hole 210 and a first opening 220. The first opening 220 is provided with a tenon gland 1 for sealing the first opening 220, and the tenon gland 1 is provided with a tenon connecting part 11 extending along a first wire inlet direction. The second connecting terminal 300 is provided with a second wire inlet hole 210′ and a second opening 220′. The second opening 220′ is provided with a mortise gland 7 for sealing the second opening 220′, and the mortise gland 7 is provided with a mortise connecting part 71 extending along a second wire inlet direction. The tenon gland 1 and the mortise gland 7 are made of insulating materials. The first wire inlet hole 210′ and the second wire inlet hole 220′ are oppositely arranged, while the tenon connecting part 11 and the mortise connecting part 71 are matched with each other to realize detachable connection of the first connecting terminal 200 and the second connecting terminal 300.

As shown in FIG. 6 to FIG. 9, in the solution above, by arranging the first connecting terminal 200 and the second connecting terminal 300, at least two wires can be clamped in wire accommodating cavities of the first connecting terminal 200 and the second connecting terminal 300 through the first wire inlet hole 210 and the second wire inlet hole 220′, and the first connecting terminal 200 and the second connecting terminal 300 can be detachably connected through the tenon connecting part 11 and the mortise connecting part 71, thereby realizing conduction of the at least two wires. The tenon gland 1 and the mortise gland 7 are matched with each other to prevent the wires from being inserted wrongly.

In this embodiment, the tenon gland 1 comprises a tenon cover body, and the tenon cover body comprises a tenon socket 12 and a tenon connecting part 11. The tenon socket 12 is fixedly installed at the first opening 220, the tenon socket 12 comprises a top surface and a first connecting surface 13 connected with a front end of the top surface, and the first connecting surface 13 is provided with a through hole corresponding to the first wire inlet hole 210. The tenon connecting part 11 is arranged at the through hole of the first connecting surface 13. The tenon connecting part 11 has a hollow cylindrical structure approximately, and is communicated with the first wire inlet hole through the through hole on the first connecting surface 13. The mortise gland 7 is fixedly installed at the second opening 220′, the mortise socket 72 comprises a top surface and a second connecting surface 73 connected with a front end of the top surface, and the second connecting surface 73 is provided with a through hole corresponding to the second wire inlet hole 210′. The tenon connecting part 71 is arranged at the through hole of the second connecting surface 73. The tenon connecting part 71 has a hollow cylindrical structure approximately, and is communicated with the second wire inlet hole 210′ through the through hole on the second connecting surface 73.

In the above embodiment, the tenon gland 1 and the mortise gland 7 are provided with locking mechanisms to fix connection states of the tenon connecting part 11 and the mortise connecting part 71. Specifically, the tenon connecting part 11 may be, but is not limited to a hollow cylindrical structure, and the tenon connecting part 11 may be a hollow cylinder or other shapes that are convenient for fitting and installing with the mortise connecting part 71, for example, a cylindrical structure with a non-circular cross section. Further, the locking mechanisms may comprise, but is not limited to one or more convex ribs 714 arranged on an outer wall of the mortise connecting part 71 and extending along a length direction of the mortise connecting part 71 and grooves 112 arranged on the tenon connecting part 11 and matched with the convex ribs 714. The mortise connecting part 71 is inserted into the tenon connecting part 11, and the tenon gland 1 and the mortise gland 7 are installed more stably through the matching of the locking mechanisms.

In the embodiment above, the tenon connecting part 11 and the mortise connecting part 71 are further installed and fixed by fastening and fixing of a clamping assembly. Specifically, the clamping assembly may comprise, but is not limited to, a cantilever-like fastener 716 arranged on the second connecting surface 73 and extending along the second wire inlet direction, and a clamping slot for fastening 116 arranged on an upper part of the tenon connecting part 11. When the first connecting terminal 200 and the second connecting terminal 300 are plugged and paired, the cantilever-like fastener 716 is fastened and fixed on the clamping slot for fastening 116. The arrangement of the clamping assembly makes the tenon connecting part 11 and the mortise connecting part 71 be more firmly connected, and can effectively prevent wrong insertion.

Further, an extension end of the cantilever-like fastener 716 is provided with a hook 717 protruding upwards, and the hook 717 is clamped in the clamping slot for fastening 116. Moreover, the hook 717 is provided with an anti-slip strip 718, which has an obvious origin of force when the tenon-and-mortise connector 100 needs to be unlocked, and at the same time has an anti-slip function and is convenient to use.

As shown in FIG. 10 to FIG. 13, in this embodiment, the first connecting terminal 200 further comprises a first connecting terminal shell 2, and the first connecting terminal shell 2 and the tenon gland 1 form a first housing at the first opening 220 in a left-right split mode. The second connecting terminal 300 further comprises a second connecting terminal shell 2′, and the second connecting terminal shell 2′ and the mortise gland 7 form a second housing at the second opening 220′ in a left-right split manner. One end of the first connecting terminal shell 2 is the first wire inlet hole 210, and the other end of the first connecting terminal shell is fixedly connected with the tenon socket 12 through the first opening 220. One end of the second connecting terminal shell 2′ is the second wire inlet hole 210′, and the other end of the second connecting terminal shell 220′ is fixedly connected with the mortise socket 72 through the second opening 220′. Specifically, the first connecting terminal shell 2 and the second connecting terminal shell 2′ have the same structure.

In the embodiment above, a top of the first connecting terminal shell 2 is a first plugboard assembly 22 extending from a top of the first wire inlet hole 210 to a rear end of the first connecting terminal shell 2, the first plugboard assembly 22 comprises at least two first plugboards 221, one end of the first plugboard 221 is fixedly integrated with the top of the first wire inlet hole 210, and the other end of the first plugboard 221 is inserted into the tenon gland 1 to form installation and fixation.

A top of the second connecting terminal shell 2′ is a second plugboard assembly 22′ extending from a top of the second wire inlet hole 210′ to a rear end of the second connecting terminal shell 2′, the second plugboard assembly 22′ comprises at least two second plugboards 221′, one end of the second plugboard 221′ is fixedly integrated with the top of the second wire inlet hole 210′, and the other end of the second plugboard 22′ is inserted into the mortise gland 7 to form installation and fixation. Further, an upper part of the tenon socket 12 is provided with a tenon insertion groove 163 matched with an insertion end of the first plugboard 221, and an upper part of the mortise socket 72 is provided with a mortise insertion groove 763 matched with an insertion end of the second plugboard 221′. The installation and fixation of the first plugboard 221 with the tenon insertion groove 163, the mortise insertion groove 763 and the second plugboard 221′ may be fixed by, but not limited to, plug-in, adhesive fixation, ultrasonic welding fixation or buckling by a clamping assembly.

In the embodiment above, the first connecting terminal shell 2 is connected with the tenon socket 12 through a first clamping assembly; and/or, the second connecting terminal shell 2′ is connected with the mortise socket 72 through a second clamping assembly. Further, the first clamping assembly comprises a first bottom-surface clamping convex head 24 which is arranged on a bottom surface of the first connecting terminal shell 2 and protrudes out, and a first bottom clamping slot which is arranged on a bottom of the tenon socket 12 and matched and fastened with the first bottom-surface clamping convex head 24; and/or, a first top-surface clamping convex head 23 which is arranged on a top surface of the first plugboard 221 and protrudes out, and a tenon top clamping slot 121 which is arranged on a top of the tenon socket 12 and matched and fastened with the first top-surface clamping convex head 23; the second clamping assembly comprises a second bottom-surface clamping convex head 24 which is arranged on a bottom surface of the second connecting terminal shell 2′ and protrudes out, and a mortise bottom clamping slot 722 which is arranged on a bottom of the mortise socket 72 and matched and fastened with the second bottom-surface clamping convex head 24′; and/or, a second top-surface clamping convex head 23′ which is arranged on a top surface of the second plugboard 221′ and protrudes out, and a mortise top clamping slot 721 which is arranged on a top of the mortise socket 72 and matched and fastened with the second top-surface clamping convex head 23′. Specifically, the first plugboard 221 is inserted into the tenon insertion groove 163, and the second plugboard 221′ is inserted into the mortise insertion groove 763. The tenon gland 1 is butted with the first connecting terminal shell 2, and the mortise gland 7 is butted with the second connecting terminal shell 2′, and then fixedly fastened and installed.

In this embodiment, a first side surface 25 of the first connecting terminal shell 2 is provided with a first coupling part 251, a second side surface 26 of the first connecting terminal shell 2 opposite to the first side surface 25 is provided with a second coupling part 261 matched with the first coupling part 251, and the first coupling part 251 or the second coupling part 261 of the first connecting terminal shell 2 is configured to be detachably coupled with a second coupling part 261 or a first coupling part 251 of another first connecting terminal shell 2 to connect the first connecting terminal shell and another first connecting terminal shell 2 in parallel. The second connecting terminal shell 2′ is provided with the same structure as the first connecting terminal shell 2.

In this embodiment, a third side surface 25′ of the second connecting terminal shell 2′ is provided with a third coupling part 251′, a fourth side surface 26 of the second connecting terminal shell 2′opposite to the third side surface 25′ is provided with a fourth coupling part 261′ matched with the third coupling part 251′, and the third coupling part 251′ or the fourth coupling part 261′ of the second connecting terminal shell 2′ is configured to be detachably coupled with a third coupling part 261′ or a fourth coupling part 251′ of another second connecting terminal shell 2′ to connect the second connecting terminal shell 2′ and another second connecting terminal shell 2′ in parallel.

In the embodiment above, the first coupling part 251 comprises a first protruding part 252 which protrudes out of the first side surface parallel to the insertion direction, and the first protruding part 252 is U-shaped. The second coupling part 252 comprises a second groove 262 recessed in the second side surface parallel to the insertion direction, and the first protruding part may be inserted into the second groove 262 of another connecting terminal shell.

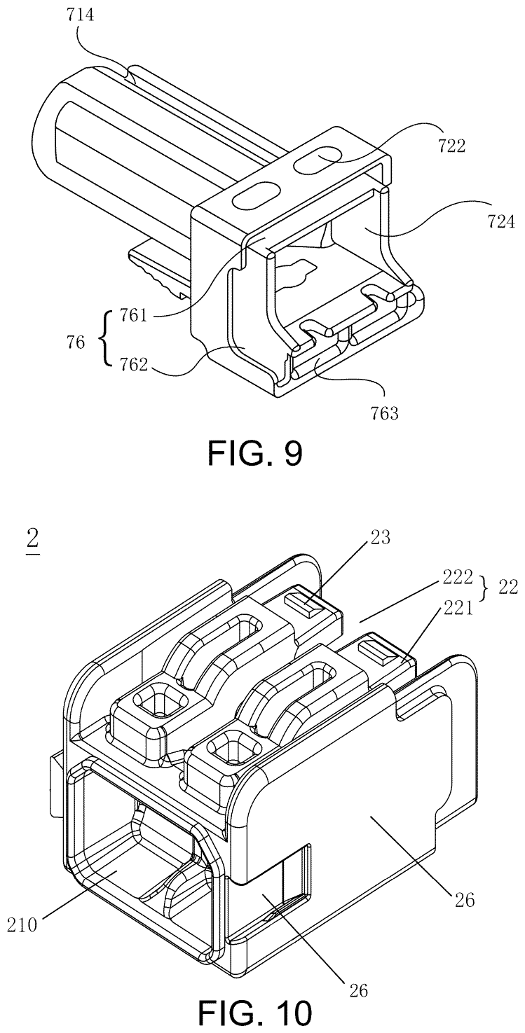

As shown in FIG. 9 to FIG. 13, in this embodiment, the first connecting terminal 200 further comprises a tenon clamping device 4, and the tenon clamping device 4 is installed in a space formed between the tenon gland 1 and the first connecting terminal shell 2. The tenon clamping device 4 comprises a tenon clamping spring 41, a tenon connecting piece 42 and a pin head 43 which are connected in sequence. The tenon clamping spring 41 is matched with the first wire inlet hole 210 to form a first clamping interface. The second connecting terminal 300 further comprises a mortise clamping device 8, and the mortise clamping device is installed in a space formed between the mortise gland 7 and the second connecting terminal shell. The mortise clamping device 8 comprises a mortise clamping spring 81, a mortise connecting piece 82 and a pin sleeve 83 which are connected in sequence. The mortise clamping spring 81 is matched with the second wire inlet hole 210′ to form a second clamping interface. When the first connecting terminal 200 is butted with the second connecting terminal 300, the pin head 43 is inserted and matched with the pin sleeve 83 to realize detachable connection between the first connecting terminal 200 and the second connecting terminal 300. Specifically, the tenon clamping device 4 and the mortise clamping device 8 are made of conductive metal materials, at least two wires respectively enter the tenon-and-mortise connector from the first wire inlet hole 210 and the second wire inlet hole 210′ and are abutted against the first clamping interface and the second clamping interface. The pin head 43 and the pin sleeve 83 are inserted and matched, so that the two wires are in a conducting state, so that short wires can be communicated through the tenon-and-mortise connector.

In the embodiment above, connection modes of the tenon clamping spring 41, the tenon connecting piece 42 and the pin head 43 may be varied. For example, the tenon clamping spring 41, the tenon connecting piece 42 and the pin head 43 may be integrally formed; or, the tenon connecting piece 42 and the pin head 43 may be integrally formed. Alternatively, the tenon clamping spring, the tenon connecting piece 42 and the pin head 43 may also be fixed by welding, bonding, and other modes, which is not limited in the embodiments of the present disclosure. Understandably, the integrated forming method can improve connection strength of the tenon clamping device 4, so that an overall structural strength of the first connecting terminal 200 is higher.

In the embodiment above, connection modes of the mortise clamping spring 81, the mortise connecting piece 82 and the pin sleeve 83 may be varied. For example, the mortise clamping spring 81, the mortise connecting piece 82 and the pin sleeve 83 may be integrally formed; or, the mortise connecting piece 82 and the pin sleeve 83 may be integrally formed. Alternatively, the mortise clamping spring 81, the mortise connecting piece 82 and the pin head 43 may also be fixed by welding, bonding, and other modes, which is not limited in the embodiments of the present disclosure. Understandably, the integrated forming method can improve connection strength of the mortise clamping device 8, so that an overall structural strength of the second connecting terminal 300 is higher.

In the embodiment above, the tenon clamping spring 4 comprises a front tenon metal sheet 413 and a tenon bus bar 415. The front tenon metal sheet comprises two tenon elastic sheets 413 arranged in parallel and a tenon fixing sheet 414 connecting the two tenon elastic sheets 413 together. One side of the tenon elastic sheet 413 is connected with the tenon fixing sheet 414. The bus bar is inverted Z-shaped, a bottom 417 of the tenon bus bar is fixedly connected with a bottom of the front mortise metal sheet, and a top of the tenon bus bar protrudes with a flaky-like tenon convex sheet 412. The tenon spring sheet is generally V-shaped and comprises a fixing edge 414 and an abutting edge 411. The fixing edge 414 of the front tenon metal sheet is located at the bottom of the tenon bus bar and is closely contacted with the bottom 417 of the tenon bus bar. Preferably, the tenon elastic sheet 413 is upwardly connected with one end of the tenon connecting piece 42 through an arc-shaped curved surface or an elastic bow part, and an upper end of the tenon elastic sheet 413 is provided with a tenon groove 418. The tenon groove 418 is arranged on both sides of the tenon elastic sheet 413 to facilitate placement of the disconnecting device 3.

In the embodiment above, the mortise clamping spring 8 comprises a front mortise metal sheet 813 and a mortise bus bar 815. The front mortise metal sheet comprises two mortise elastic sheets 813 arranged in parallel and a mortise fixing sheet 814 connecting the two mortise elastic sheets 813 together. One side of the mortise elastic sheet 813 is connected with the mortise fixing sheet 814. The bus bar is inverted Z-shaped, a bottom 817 of the mortise bus bar is fixedly connected with a bottom of the front mortise metal sheet, and a top of the mortise bus bar protrudes with a flaky-like mortise convex sheet 812. The mortise spring is generally V-shaped and comprises a fixing edge 818 and an abutting edge 811. The fixing edge 814 of the front mortise metal sheet is located at the bottom of the mortise bus bar and is closely contacted with the bottom 817 of the mortise bus bar. Preferably, the mortise elastic sheet 813 is upwardly connected with one end of the mortise connecting piece 82 through an arc-shaped curved surface or an elastic bow part, and an upper end of the mortise elastic sheet 813 is provided with a mortise groove 818. The mortise groove 818 is arranged on both sides of the mortise elastic sheet 813 to facilitate placement of the disconnecting device 3′.

In the embodiment above, the tenon connecting piece 42 may be, but is not limited to a trapezoidal flaky structure to connect the bus bar with the pin head 43, the tenon connecting piece 42 and the bus bar may be integrally formed, and the mortise connecting piece 82 may be, is but not limited to the trapezoidal flaky structure to connect a rear mortise metal sheet 815 with the pin sleeve 83.

In the embodiment above, a side wall of the pin sleeve 83 is provided with a limiting lug 833. Alternatively, the limiting lug 831 may be stacked and arranged on both sides of the side wall of the p pin sleeve 83, and the limiting lug 831 can enhance a plug-in force of the tenon-and-mortise connector.

In the embodiment above, the pin sleeve 83 is provided with one expansion joint 833 penetrating through a tube wall. In order to facilitate expansion and contraction when pin sleeve 83 is inserted into or removed from the pin head 43, the pin sleeve 83 is further provided with one expansion joint 832 not penetrating the tube wall, so that the pin sleeve 83 is more elastic. Further, the pin sleeve 83 may be, but is not limited to a hollow structure.

In the embodiment above, the pin head 43 may be, but is not limited to a cylindrical pin. The upper part of the pin head 43 is provided with one expansion joint 431, and a width of the expansion joint 431 gradually narrows towards a pin opening direction, so that the pin head 43 is elastic, which ensures the flexibility and elasticity of the tenon-and-mortise connector when wiring, and is not easy to cause deformation during installation. Certainly, both the pin head 43 and the pin sleeve 83 may be formed without any cracks or cracked slots, and are also elastic.

As shown in FIG. 18 to FIG. 21, the first connecting terminal 200 and the second connecting terminal 300 further comprise a disconnecting device. The disconnecting device comprises a first disconnecting device 3 and a second disconnecting device 3′. One end of the first disconnecting device 3 extends into the first housing for squeezing the tenon clamping spring to open or close a first clamping interface, and the other end of the first disconnecting device 3 protrudes out of the first housing. One end of the second disconnecting device 3′ extends into the second housing for squeezing the mortise clamping spring to open or close a second clamping interface, and the other end of the second disconnecting device 3′ protrudes out of the second housing. The first disconnecting device 3 and the second disconnecting device 3′ have the same structure.

In the embodiment above, the first disconnecting device comprises a first connecting arm 31 and two opposite first supporting arms 32 connected with the first connecting arm 31. One end of the first supporting arm 32 is connected with the first connecting arm 31, and the other end of the first supporting arm 32 is a free end and extends into the first connecting terminal shell 2 to squeeze the tenon clamping spring 41. An end part position of the first connecting arm 31 is provided with an anti-skid stripe, so that the first disconnecting device can be conveniently moved or lifted to rotate during manual operation. Preferably, both sides of a front end of the first connecting arm 31 may be tightened inward. A bottom of the supporting arm is triangular, an inner side of the supporting arm is provided with a protruding triangular-like first supporting part 34, and an upper part of the first supporting part 34 is provided with a second supporting part 35. The first supporting part 34 is matched with the tenon groove 418 of the tenon elastic sheet 413, and the second supporting part 35 is abutted against flanges at two sides of the first plugboard 221.

When the clamping interface of the tenon clamping device 4 is in a closed position, the first connecting arm 31 of the first disconnecting device is in a horizontal state or near the horizontal state. When the first connecting arm 31 of the first disconnecting device is pulled, the first supporting part 34 is abutted against the tenon groove 418 of the tenon elastic sheet 413, and the second supporting part 35 is abutted against the flanges at the two sides of the first plugboard 221. With rotation of an anti-drop device, the first supporting part 34 gradually squeezes the elastic sheet and further opens the clamping interface. When the tenon-and-mortise connector is in an open position, the first supporting part 34 and the tenon groove 418 are connected.

In the embodiment above, the disconnecting device 3′ comprises a second connecting arm 31′ and two opposite supporting arms 32′ connected with the second connecting arm 31′. One end of the second supporting arm 32′ is connected with the second connecting arm 31′, and the other end of the second supporting arm 32′ is a free end and extends into the second connecting terminal shell 2′ to squeeze the mortise clamping spring 81. An end part position of the second connecting arm 31′ is provided with an anti-skid stripe, so that the second disconnecting device 3′ can be conveniently moved or lifted to rotate during manual operation. Preferably, both sides of a front end of the second connecting arm 31′may be tightened inward. A bottom of the supporting arm is triangular, an inner side of the supporting arm is provided with a protruding triangular-like third supporting part 34′, and an upper part of the third supporting part 34′ is provided with a fourth supporting part 35′. The third supporting part 34′ is matched with the mortise groove 818 of the mortise elastic sheet 813, and the fourth supporting part 35′ is abutted against flanges at two sides of the second plugboard 221′.

When the clamping interface of the mortise clamping device 8 is in the closed position, the second connecting arm 31′ of the second disconnecting device 3′ is in a horizontal state or near the horizontal state. When the second connecting arm 31′ of the second disconnecting device 3′ is pulled, the third supporting part 34′ is abutted against the mortise groove 818 of the mortise elastic sheet 813, and the fourth supporting part 35′ is abutted against the flanges at the two sides of the second plugboard 221′. With the rotation of the anti-drop device, the third supporting part 34′ gradually squeezes the elastic sheet and further opens the clamping interface. When the tenon-and-mortise connector is in the open position, the third supporting part 34′ and the mortise groove 818 are connected.

In this embodiment, the tenon gland 1 is provided with one tenon test port 14, and/or, the mortise gland is provided with at least one mortise test port 74. Further, the tenon test port 14 and the mortise test port 74 may be arranged on the upper part of the tenon socket 12 to facilitate the detection of electrical conduction.

As shown in FIG. 22 to FIG. 25, in this embodiment, the tenon-and-mortise connector further comprises a wire protection box 400. The wire protection box 400 comprises an upper cover 5 and a lower seat 6. The upper cover is hinged on the lower seat 6. Further, a size of the wire protection box is greater than the first connecting terminal 200 and the second connecting terminal 300. The first connecting terminal 200 and the second connecting terminal 300 are respectively installed in two wire protection boxes to protect the wires.

As shown in FIG. 22 to FIG. 25, a positioning space 410 for positioning the first connecting terminal 200 or the second connecting terminal 300 is formed between the lower seat 6 and the upper cover 5, a fitting groove 420 for exposing the tenon connecting part or the mortise connecting part of the first connecting terminal 200 or the second connecting terminal 300 is arranged at the front of the positioning space 410, and a through hole 430 for leading a wire to penetrate and extend to an outside is arranged at the rear of the positioning space 410.

In the embodiment above, the tenon gland 1 further comprises a tenon upper cover clamping slot 15 arranged at an end part of the tenon socket. The mortise gland 7 further comprises a mortise upper cover clamping slot 75 arranged at an end part of the mortise socket. The upper cover 5 comprises an upper cover wall 52 and two upper cover side walls 53 connected with the upper cover wall 52. A front section of the upper cover side wall 53 is provided with an upper cover groove 531 for placing the first connecting terminal 200/the second connecting terminal 300. A front end of the upper cover groove 531 is provided with an upper cover clamping port 55 which is matched with the tenon upper cover clamping slot 15 or the mortise upper cover clamping slot 75. An inner side of the upper cover wall 52 is provided with a convex strip 56 connected with the two upper cover side walls 53, and the convex strip 56 is used for positioning the first connecting terminal 200 or the second connecting terminal 300.

In the embodiment above, a rear side of the upper cover wall 52 is provided with a jack 521, a rear part of the jack 521 is fixedly connected with a wire clip 54, the wire clip 54 comprises a connecting section 541 and a cantilever section 542, the connecting section 541 is fixed on the rear part of the jack 521 of the upper cover wall, and the cantilever section 542 extends into the upper cover groove 531, is deformable and is used for elastically abutting against a wire inserted into the through hole 430. It can be understood that the cantilever section 52 has an elastic force, so the cantilever section can clamp wires of different sizes by the elastic force thereof.

In the embodiment above, the cantilever section 542 is bent. Specifically, after extending, the cantilever section 542 is bent towards an insertion direction of the wire and is abutted against the wire. It should be noted that the bent cantilever section can improve strength of the wire clip 54, and at the same time, can fix the wire inserted into the wire protection box more stably.

In this embodiment, two sides of a front end of the upper cover 5 are provided with rotating shafts 51, and two sides of a front end of the lower seat 6 are provided with fixing arms 61 matched with the rotating shafts 51. Specifically, the rotating shaft 51 is buckled with the fixing arm, and the first connecting terminal 200 or the second connecting terminal 300 can be installed in the wire protection box 400 when the upper cover 5 is in the open state. When the upper cover 5 is in the closed state, the wire protection box 400 buckles the first connecting terminal 200 or the second connecting terminal 300 in the wire protection box 400. Preferably, an I-shaped locking pin is arranged at a tail end of the rotating shaft 51, which facilitates the installation of the first connecting terminal 200 or the second connecting terminal 300 when the wire protection box 400 is in the open state, and then, the wire protection box 400 further ensures the stability and safety of the first connecting terminal 200 or the second connecting terminal 300 when the upper cover 5 is in the closed state.

In this embodiment, the lower seat 6 comprises a lower seat base 62 and two lower seat side walls 63 connected with the lower seat base 62. A front end of the lower seat side wall 63 is provided with a lower seat groove 631 for placing the first connecting terminal 200/the second connecting terminal 300, a middle part of the lower seat base 62 is provided with a lower seat jack 621, and the lower seat jack is provided with an elastically deformable fastener 66. The fastener 66 is used to open the wire protection box 400 in a buckled state. When the first connecting terminal 200/the second connecting terminal 300 is clamped into the lower seat groove 631, the fastener 66 is used for fastening the first connecting terminal 200/the second connecting terminal 300 to position the first connecting terminal 200/the second connecting terminal 300 and prevent the first connecting terminal 200/the second connecting terminal 300 from moving.

In this embodiment, the wire protection box 400 comprises a clamping assembly. The clamping assembly comprises a clamping piece 67 arranged at a rear end of the lower seat 6. The clamping piece 67 is a strip-shaped plate structure arranged longitudinally and extending upwards from the lower seat base 62 along the lower seat side walls 63, and a tail end of the clamping piece 67 is provided with a clamping buckle. A position at a rear end of the upper cover side wall 53 corresponding to the clamping piece is provided with a clamping groove 57 which realizes clamping with the clamping piece 67. It can be understood that the clamping assembly can make the wire protection box firmer when in use.

A joint of the clamping piece 67 and the lower seat base 62 is provided with two racks transversely penetrating the lower seat base 62. When the upper cover and the lower seat are closed, the racks can facilitate the fixing of the wire.

In this embodiment, an outer side of the lower seat side wall 63 is provided with an anti-skid stripe 65. The anti-skid stripe 65 can play an anti-slip role during installation and use.

As a preferred embodiment, a plurality of the connecting terminals described in the first embodiment may be connected in parallel to form a multi-port connecting terminal row for use.

As a preferred embodiment, a plurality of the connecting terminals described in the first embodiment may be connected in parallel to form a multi-port connecting terminal row for use.

### Second Embodiment

The same components, connection modes and structures are used in the same place as in the first embodiment, which are not described repeatedly here.

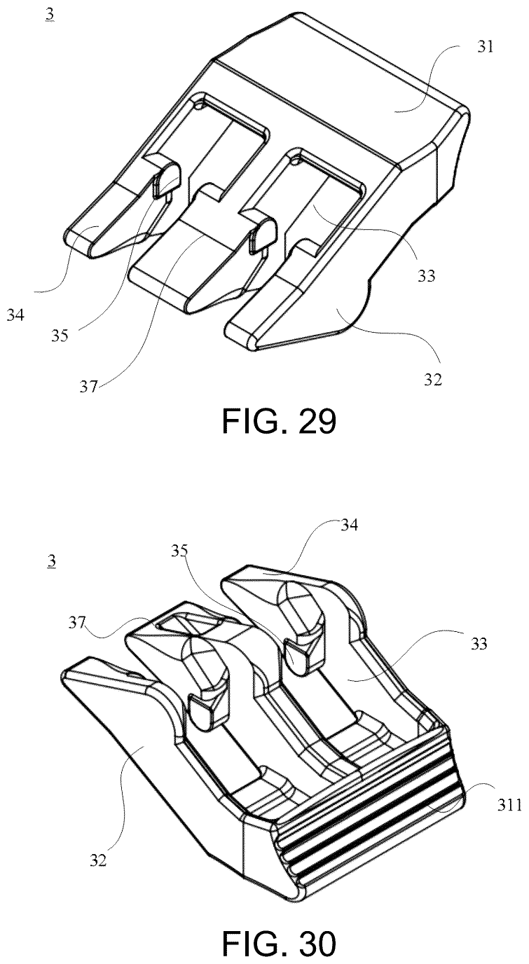

As shown in FIG. 29 and FIG. 30, this embodiment improves the disconnecting device 3 of the tenon-and-mortise connector. The disconnecting device 3 of this embodiment also comprises the connecting arm 31, two parallel supporting arms 32 connected with the connecting arm 31, and one coupling arm 37 connected with the connecting arm 31 and located in the middle of the supporting arms 32. The supporting arm 32 and the coupling arm 37 form two accommodating areas 33. It can be understood that in this embodiment, the disconnecting device 3 is a connected structure, which means that, one disconnecting device 3 can simultaneously open or close a plurality of tenon clamping devices and/or mortise clamping devices, thus simplifying the operation.

### Third Embodiment

The same components, connection modes and structures are used in the same place as in the first embodiment, which are not described repeatedly here.

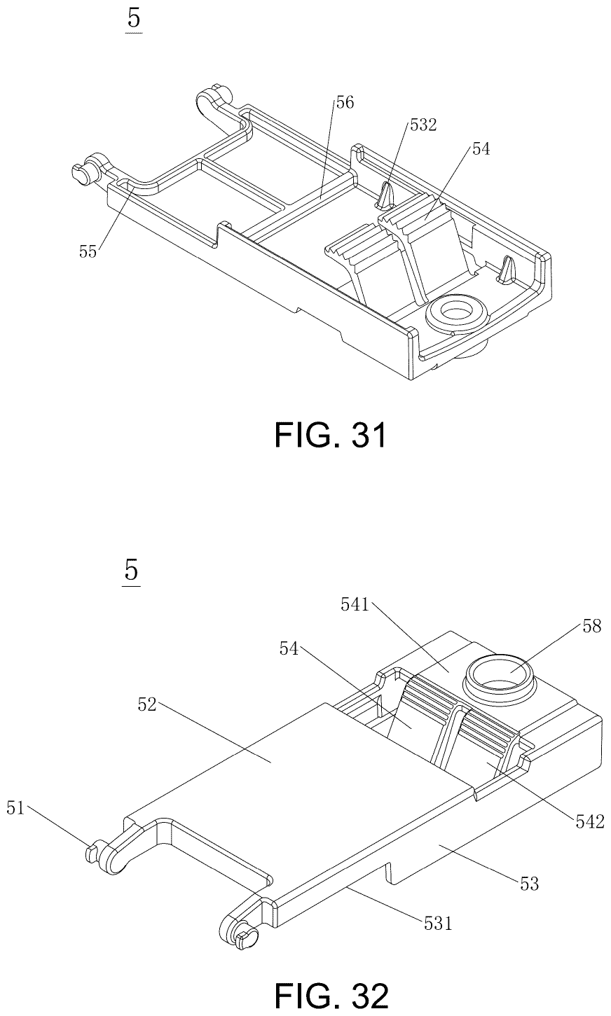

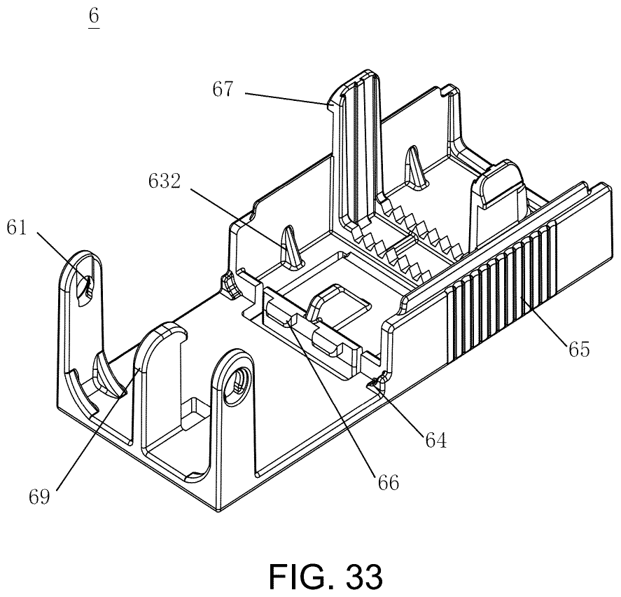

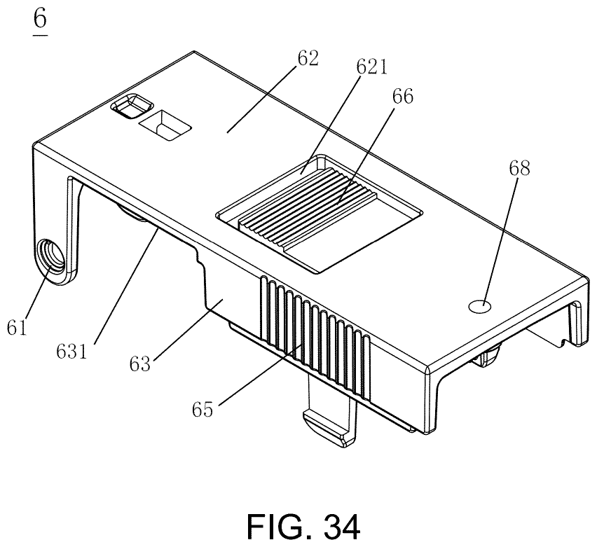

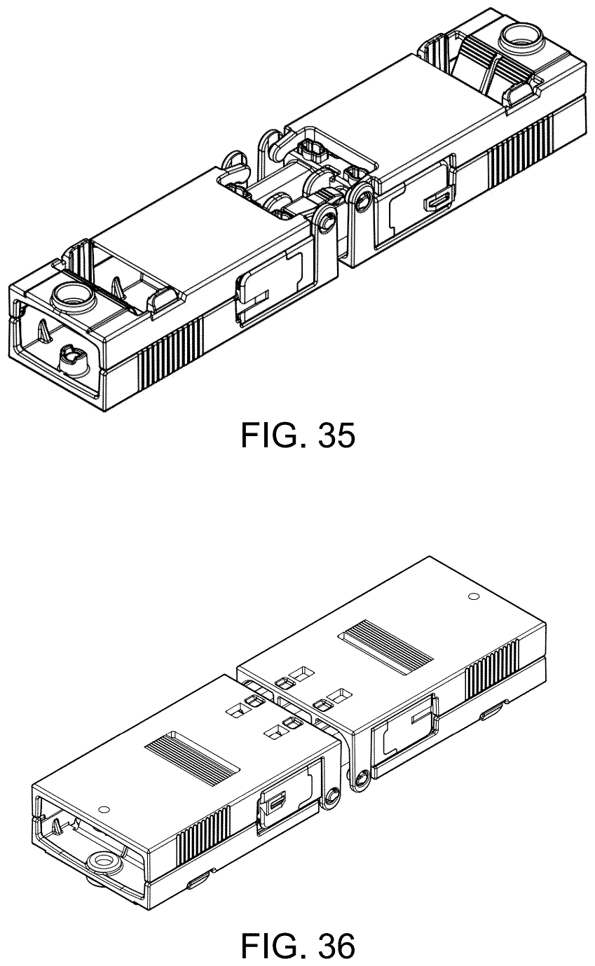

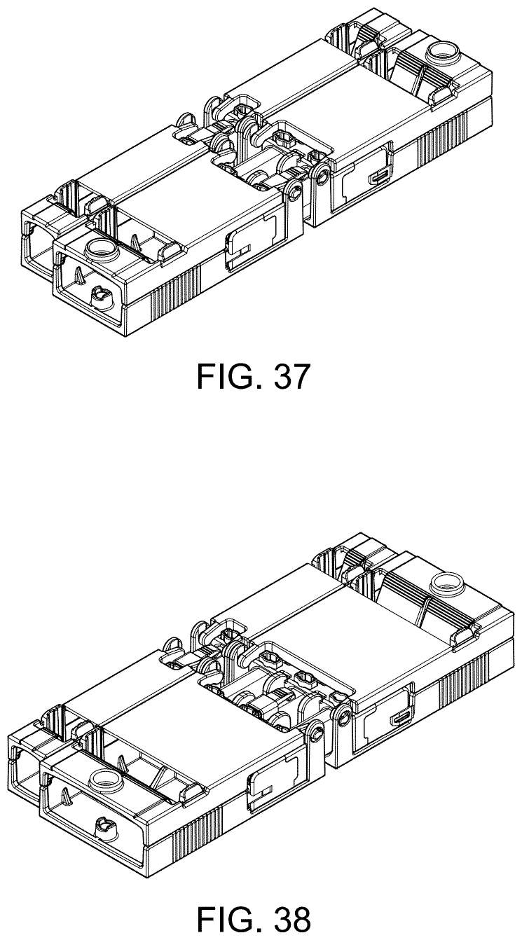

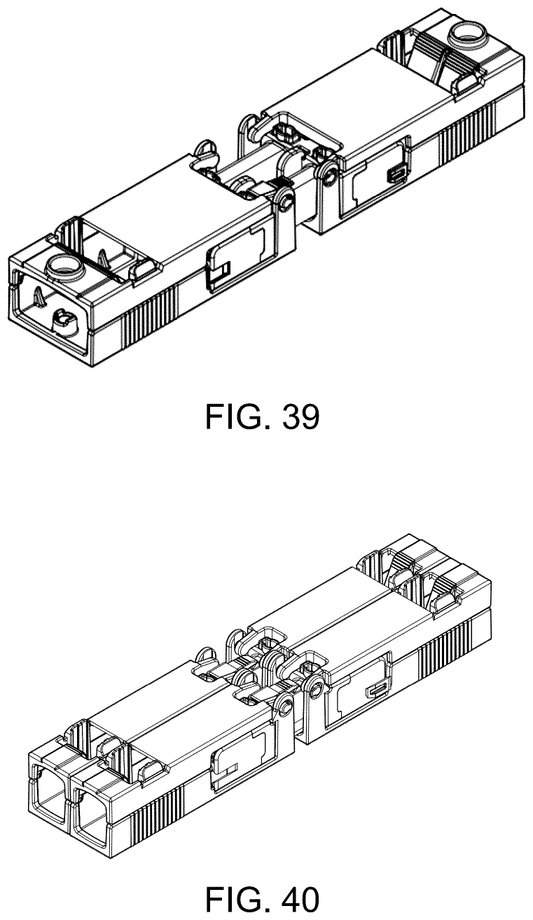

As shown in FIG. 31 to FIG. 40, the wire protection box 400 is improved in this embodiment. A positioning space 410 for positioning at least two first connecting terminals 200 or at least two second connecting terminals 300 is formed between the lower seat 6 and the upper cover 5. Moreover, at least two fitting grooves 420 for exposing the tenon connecting part or the mortise connecting part of the first connecting terminal 200 or the second connecting terminal 300 are arranged at the front of the positioning space 410, and then at least two through holes 430 for leading a wire to penetrate and extend to an outside are arranged at the rear of the positioning space 410. Specifically, the first connecting terminal 200 and the second connecting terminal 300 are respectively installed in two wire protection boxes and used in different places. In this embodiment, one tenon-and-mortise connector in the first embodiment and the tenon-and-mortise connector in this embodiment can be connected in parallel through the first coupling part and the second coupling part to form a multi-port connecting terminal row for use.

In this embodiment, an inner side of the upper cover side wall 53 is provided with at least one reinforcing rib 532. And/or, the lower seat side wall 63 is provided with at least one reinforcing rib 632. The reinforcing rib can strengthen the strength of the two side walls of the upper cover 5 and the lower seat 6, thereby reducing a deformation degree of the wire protector box during use.

In this embodiment, the upper cover 5 and the lower seat 6 may also be connected by a screw. Specifically, an end part of the upper cover wall 52 is provided with a screw hole 58, and a corresponding position of the lower seat 62 is provided with a screw mating hole 68, so that the wire protection box can be reinforced by a screw.

The technical features of the above embodiments can be combined in any way. In order to simplify the description, not all possible combinations of the technical features in the above embodiments are described. However, as long as there is no contradiction in the combinations of these technical features, they should be considered as the scope recorded in this specification.

The above embodiments merely express several embodiments of the present disclosure, and the descriptions thereof are more specific and detailed, but cannot be understood as a limitation to the scope of the present disclosure. It should be pointed out that for those of ordinary skills in the art, several adjustments and improvements can be made without departing from the concept of the present disclosure, and these adjustments and improvements shall all fall within the protection scope of the present disclosure. Therefore, the patent scope of the present disclosure shall be subjected to the claims appended.

1. A tenon-and-mortise connector, comprising a first connecting terminal and a second connecting terminal, wherein:
the first connecting terminal comprises a first connecting terminal shell and a tenon gland, one end of the first connecting terminal shell is provided with a first wire inlet hole, the tenon gland is provided with a tenon connecting part extending along a first wire inlet direction, a tenon clamping device is arranged in the first connecting terminal, and the tenon clamping device comprises a tenon clamping spring and a first contact connected with the tenon clamping spring;
the second connecting terminal comprises a second connecting terminal shell and a mortise gland, one end of the second connecting terminal shell is provided with a second wire inlet hole, the mortise gland is provided with a mortise connecting part capable of being plugged with the tenon connecting part, a mortise clamping device is arranged in the second connecting terminal, and the mortise clamping device comprises a mortise clamping spring and a second contact connected with the mortise clamping spring;
the first connecting terminal and/or the second connecting terminal is provided with a disconnecting device, and the disconnecting device is used for opening or closing the tenon clamping device and/or the mortise clamping device; and
the tenon connecting part and the mortise connecting part are capable of being plugged, and after the tenon connecting part and the mortise connecting part are plugged, the first contact and the second contact are electrically connected.

2. The tenon-and-mortise connector according to claim 1, wherein:
the tenon gland comprises a tenon socket and the tenon connecting part, the tenon socket comprises a top surface and a first connecting surface connected with a front end of the top surface, and the tenon connecting part is formed on the first connecting surface; and
the mortise gland comprises a mortise socket and the mortise connecting part, the mortise socket comprises a top surface and a second connecting surface connected with a front end of the top surface, and the mortise connecting part is formed on the second connecting surface;
the tenon connecting part and the tenon socket form a convex shape, and/or, the mortise connecting part and the mortise socket form a convex shape.

3. The tenon-and-mortise connector according to claim 1, wherein:
the tenon gland and/or the mortise gland are provided with locking mechanisms to fix connection states of the tenon connecting part and the mortise connecting part, and the locking mechanism comprises one or more convex ribs arranged on an outer wall of the mortise connecting part in a length direction of the mortise connecting part, and grooves arranged on the tenon connecting part and matched with the convex ribs.

4. The tenon-and-mortise connector according to claim 2, wherein:
a top of the first connecting terminal shell is a first plugboard assembly extending from a top of the first wire inlet hole to a rear end of the first connecting terminal shell, the first plugboard assembly comprises at least one first plugboard, one end of the first plugboard is fixedly integrated with the top of the first wire inlet hole, and the other end of the first plugboard is inserted into the tenon gland to form installation and fixation; and
a top of the second connecting terminal shell is a second plugboard assembly extending from a top of the second wire inlet hole to a rear end of the second connecting terminal shell, the second plugboard assembly comprises at least one second plugboard, one end of the second plugboard is fixedly integrated with the top of the second wire inlet hole, and the other end of the second plugboard is inserted into the mortise gland to form installation and fixation.

5. The tenon-and-mortise connector according to claim 4, wherein the first connecting terminal shell is fixedly connected with the tenon socket through a first clamping assembly;
and/or, the second connecting terminal shell is fixedly connected with the mortise socket through a second clamping assembly.

6. The tenon-and-mortise connector according to claim 5, wherein:
the first clamping assembly comprises a first bottom-surface clamping convex head which is arranged on a bottom surface of the first connecting terminal shell and protrudes out, and a tenon bottom clamping slot which is arranged on a bottom of the tenon socket and matched and fastened with the first bottom-surface clamping convex head; and/or, a first top-surface clamping convex head which is arranged on a top surface of a first plugboard and protrudes out, and a tenon top clamping slot which is arranged on a top of the tenon socket and matched and fastened with the first top-surface clamping convex head; and
the second clamping assembly comprises a second bottom-surface clamping convex head which is arranged on a bottom surface of the second connecting terminal shell and protrudes out, and a mortise bottom clamping slot which is arranged on a bottom of the mortise socket and matched and fastened with the second bottom-surface clamping convex head; and/or, a second top-surface clamping convex head which is arranged on a top surface of a second plugboard and protrudes out, and a mortise top clamping slot which is arranged on a top of the mortise socket and matched and fastened with the second top-surface clamping convex head.

7. The tenon-and-mortise connector according to claim 1, wherein the second contact is a pin sleeve with a sleeve-like structure, the first contact is a pin head extending into the pin sleeve to realize electrical connection with the pin sleeve, the tenon clamping device further comprises a tenon connecting piece, and the tenon clamping spring, the tenon connecting piece and the pin head are sequentially connected, and/or the mortise clamping device further comprises a mortise connector, and the mortise clamping spring, the mortise connector and the pin sleeve are sequentially connected.

8. The tenon-and-mortise connector according to claim 7, wherein the tenon clamping spring comprises a front tenon metal sheet and a tenon bus bar, and the tenon connecting piece connects the bus bar with the pin head.

9. The tenon-and-mortise connector according to claim 1, wherein the disconnecting device comprises a first disconnecting device and a second disconnecting device, one end of the first disconnecting device extends into a first housing for squeezing the tenon clamping spring to open or close the tenon clamping device; and one end of the second disconnecting device extends into a second housing for squeezing the mortise clamping spring to open or close the mortise clamping device, and the disconnecting device comprises a connecting arm, two side-by-side supporting arms connected with the connecting arm and a coupling arm located in the middle of the supporting arms.

10. The tenon-and-mortise connector according to claim 1, wherein the tenon-and-mortise connector further comprises a wire protection box, the wire protection box comprises an upper cover and a lower seat, and the upper cover is hinged on the lower seat.

11. The tenon-and-mortise connector according to claim 10, wherein the tenon gland is provided with at least one tenon upper cover clamping slot, and/or the mortise gland is provided with at least one mortise upper cover clamping slot; and the upper cover comprises an upper cover wall and two upper cover side walls connected with the upper cover wall, and a front end of the upper cover side wall is provided with an upper cover clamping port matched with the tenon upper cover clamping slot or the mortise upper cover clamping slot.

12. The tenon-and-mortise connector according to claim 10, wherein a rear side of the upper cover wall is provided with a jack, a rear part of the jack is fixedly connected with a wire clip, the wire clip comprises a connecting section and a cantilever section, the connecting section is fixed on the rear part of the jack of the upper cover wall, and the cantilever section extends into an upper cover groove, is deformable and is used for elastically abutting against a wire inserted into a through hole.

13. The tenon-and-mortise connector according to claim 10, wherein the lower seat comprises a lower seat base and two lower seat side walls connected with the lower seat base, a front end of the lower seat side wall is provided with a lower seat groove for placing the first connecting terminal or the second connecting terminal, the lower seat base is further provided with a lower seat jack, and the lower seat jack is provided with an elastically deformable fastener.

14. The tenon-and-mortise connector according to claim 10, wherein two sides of a front end of the upper cover are provided with rotating shafts, and two sides of a front end of the lower seat are provided with fixing arms matched with the rotating shafts, and the upper cover is hinged on the fixing arms of the lower seat through the rotating shafts.

15. The tenon-and-mortise connector according to claim 10, wherein the upper cover and the lower seat are buckled by a clamping assembly, the clamping assembly comprises a clamping piece arranged at a rear end of the lower seat, and a position at a rear end of the upper cover side wall corresponding to the clamping piece is provided with a clamping groove which realizes clamping with the clamping piece.
